(19) United States
(12) Patent Application Publication
(10) Pub. No.: US 2026/0100412 A1
(43) Pub. Date: Apr. 9, 2026

(54) SOLID-STATE ELECTROLYTE AND CELL USING THE SAME

(71) Applicant: FORMOSA SMART ENERGY TECH CORPORATION, Taipei City (TW)

(72) Inventors: Dheeraj KUMAR MAURYA, Xinbei City (TW); Behrouz BAZRI, Keelung City (TW); Yuan-Ting HUNG, Kaohsiung City (TW); Ru-Shi LIU, New Taipei City (TW); Da-Hua WEI, New Taipei City (TW); Hui-Chi LIU, Taipei City (TW); Ruey-Yu WANG, Taipei City (TW)

(21) Appl. No.: 19/264,424

(22) Filed: Jul. 9, 2025

(30) Foreign Application Priority Data
Oct. 7, 2024 (TW) 113138152

(51) Int. Cl. H01M 10/0562; H01M 4/02; H01M 4/40; H01M 4/525; H01M 4/58; H01M 10/0525; H01M 10/0565; H01M 10/0568

(52) U.S. Cl. CPC H01M 10/0562; H01M 4/405; H01M 4/525; H01M 4/5825; H01M 10/0525; H01M 10/0565; H01M 10/0568; H01M 2004/027; H01M 2004/028; H01M 2300/0077; H01M 2300/0082; H01M 2300/0088

(57) ABSTRACT

A solid-state electrolyte for lithium-ion cell is provided. The solid-state electrolyte includes a garnet-type solid-state electrolyte and a polymer filler, wherein the polymer filler is dispersed within the garnet-type solid-state electrolyte. The garnet-type solid-state electrolyte does not contain lithium carbonate, and the content of the garnet-type solid-state electrolyte is 60 wt % or more based on the total weight of the garnet-type solid-state electrolyte and the polymer filler.

### CLAIM FOR PRIORITY

This application claims the benefit of Taiwan Patent Application No. 113138152 filed on Oct. 7, 2024, the subject matters of which are incorporated herein in their entirety by reference.

### BACKGROUND

### Field of the Invention

The present invention provides a solid-state electrolyte for lithium-ion cells, especially a solid-state electrolyte which comprises a garnet-type solid-state electrolyte and a polymer filler at a specific ratio. The present invention also provides a lithium-ion solid-state cell comprising the solid-state electrolyte.

### Descriptions of the Related Art

In response to global warming and climate change, energy conservation and carbon reduction have become top priorities worldwide. Among these, improving energy storage efficiency is a key issue in achieving energy conservation. Lithium-ion cells are one of the most widely used energy storage systems. Conventional lithium-ion cells utilize liquid-state electrolytes; however, such electrolytes pose several safety concerns, including leakage, and the risk of internal short circuits or even explosions caused by dendritic lithium breaking through separator. As a result, recent research on lithium-ion cells has focused on the development of solid-state electrolytes. Garnet-type solid-state electrolytes are one of the most promisingly solid-state electrolytes due to their high mechanical strength, high ionic conductivity (about 10⁻³S/cm to 10⁻⁴ S/cm), and high chemical stability.

However, full solid-state garnet-type ceramic electrolyte sheets are inherently brittle and difficult to fabricate into forms. During processing, they are prone to cracking under pressure, significantly limiting their practical applications. In addition, garnet-type solid-state electrolytes tend to react with carbon dioxide (CO₂) and water (H₂O) present in the air, resulting in the formation of a passivation layer of lithium carbonate (Li₂CO₃) on the surface. This passivation layer increases the interfacial impedance between the full solid-state garnet-type ceramic electrolyte sheet and lithium metal.

### SUMMARY

In view of the above technical issues, the present invention provides a solid-state electrolyte that combines a garnet-type solid-state electrolyte, which is free of lithium carbonate, with a polymer filler. The solid-state electrolyte of the present invention simultaneously possesses good flexibility, good mechanical strength, and high ionic conductivity. The solid-state electrolyte of the present invention is particularly suitable for application in lithium-ion cells. The lithium-ion cells provided herein exhibit good mechanical performances, high ionic conductivity, high electrochemical stability, and superior cycling stability.

Therefore, an objective of the present invention is to provide a solid-state electrolyte for lithium-ion cells, which comprises a garnet-type solid-state electrolyte and a polymer filler, wherein the polymer filler is dispersed within the garnet-type solid-state electrolyte, and the garnet-type solid-state electrolyte does not contain lithium carbonate or is free of it, and wherein the content of the garnet-type solid-state electrolyte is 60 wt % or more based on the total weight of the garnet-type solid-state electrolyte and the polymer filler.

In one embodiment of the present invention, the garnet-type solid-state electrolyte is selected from the group consisting of Li_{6.4}La₃Zr_{1.4}Ta_{0.6}O₁₂ (LLZTO), Li_{6.4}La₃Zr₂Al_{0.2}O₁₂ (LLZAO), Li_{6.4}La₃Zr₂Ga_{0.2}O₁₂ (LLZGO), Li_{6.25}Al_{0.20}La₃Zr_{1.85}Nb_{0.15}O₁₂ (LALZNO), and combinations thereof.

In one embodiment of the present invention, the garnet-type solid-state electrolyte is provided by garnet-type solid-state electrolyte ceramic powder that does not contain lithium carbonate. The aforementioned ceramic powder has an average particle size of less than 100 μm.

In one embodiment of the present invention, the polymer filler is made of a material selected from the group consisting of polytetrafluoroethene (PTFE), poly(ethylene oxide) (PEO), polyacrylonitrile (PAN), poly(methyl methacrylate) (PMMA), and combinations thereof.

In one embodiment of the present invention, based on the total weight of the garnet-type solid-state electrolyte and the polymer filler, the content of the polymer filler ranges from 0.1 wt % to less than 40 wt %, preferably from 0.1 wt % to less than 10 wt %, and more preferably from 0.1 wt % to less than 5 wt %.

Another objective of the present invention is to provide a lithium-ion cell, which comprises a positive electrode, a negative electrode, and the aforementioned solid-state electrolyte.

In one embodiment of the present invention, the positive electrode is made of a material selected from the group consisting of LiFePO₄ (LFP), LiCoO₂ (LCO), lithium nickel cobalt aluminum oxide (NCA), and lithium nickel cobalt manganese oxide (NCM).

In one embodiment of the present invention, the negative electrode is made of a material selected from the group consisting of lithium metal, a lithium-indium alloy, a lithium-aluminum alloy, a silicon-lithium alloy, and combinations thereof.

In one embodiment of the present invention, the lithium-ion cell further comprises an ionic liquid between the positive electrode and the solid-state electrolyte, as well as between the negative electrode and the solid-state electrolyte, wherein the ionic liquid contains a lithium salt.

In one embodiment of the present invention, the lithium salt is selected from the group consisting of lithium bis(trifluoromethanesulfonyl)imide (LiTFSI), LiPF₆, LiBF₄, LiClO₄, LiAsF₆, LiCF₃SO₃, and combinations thereof.

To render the above objectives, technical features and advantages of the present invention more apparent, the present invention will be described in detail with reference to some embodiments hereinafter.

### BRIEF DESCRIPTION OF THE DRAWINGS

FIG. 1 is a Raman spectrum of the garnet-type solid-state electrolyte ceramic powders of Example 1 and Comparative Example 1.

FIG. 2 is a photograph of the solid-state electrolyte of Example 1.

FIG. 3 is an electron microscope image of the solid-state electrolyte of Example 1.

FIG. 4 is a thermogravimetric analysis curve of the solid-state electrolyte of Example 1.

FIG. 5 shows the impedance analysis results of the symmetric cells of Example 1 and Comparative Example 1.

FIG. 6 shows the voltage-time profiles of the symmetrical cells of Example 1 and Comparative Example 1.

FIG. 7 shows the impedance analysis results of the lithium-ion cells of Example 1 and Comparative Example 1.

FIG. 8 shows the initial charge-discharge curve graph of the lithium-ion cells of Example 1 and Comparative Example 1.

### DETAILED DESCRIPTION

Hereinafter, some embodiments of the present invention will be described in detail. However, the present invention may be embodied in various embodiments and should not be limited to the embodiments described in the specification.

Unless otherwise specified, the expressions “a,” “the,” or the like recited in the specification and the claims should include both the singular and the plural forms.

Unless otherwise specified, the term “positive electrode” as used in this specification and the appended claims refers to the cathode during cell discharge, and the term “negative electrode” as used in this specification and the appended claims refers to the anode during cell discharge.

Unless otherwise specified, the unit for weight average molecular weight (Mw) as used in this specification and the appended claims is “Dalton”.

As used herein, the term “ionic liquid” refers to ionic compounds in a liquid state, particularly the compound that exhibits lithium-ion mobility enhancement properties and is capable of dissolving possess lithium salts.

As used herein, the term “polymer-in-ceramic (PIC)” refers to a composite material of a polymer and a ceramic, wherein the content of the ceramic is larger than 50 wt % based on the total weight of the composite material, that is, the content of the polymer is less than 50 wt %.

The advantage of the present invention over the prior art lies in the addition of a relatively low amount of polymer filler to a garnet-type solid-state electrolyte to form a polymer-in-ceramic solid-state electrolyte. This approach provides a solid-state electrolyte that possesses both good flexibility and mechanical strength, as well as high ionic conductivity. The solid-state electrolyte can be applied to lithium-ion cells, and the resulting lithium-ion cells exhibit good mechanical performance, high ionic conductivity, high electrochemical stability, and superior cycling stability. Further details about the solid-state electrolyte and its applications are elaborated below.

### 1. Solid-State Electrolyte

The solid-state electrolyte of the present invention comprises a garnet-type solid-state electrolyte and a polymer filler, wherein the polymer filler is dispersed within the garnet-type solid-state electrolyte.

### 1.1. Garnet-Type Solid-State Electrolyte

Garnet-type solid-state electrolytes are one type of oxide-type electrolytes, with Li₇La₃Zr₂O₁₂ (LLZO) as a representative example. In general, garnet-type solid-state electrolytes exist in a high-temperature metastable cubic phase and a low-temperature/room-temperature stable tetragonal phase. In the tetragonal phase, the lithium sites are fully (100%) occupied, whereas the cubic phase contains lithium vacancies, resulting in the ionic conductivity of the tetragonal phase garnet being two orders of magnitude lower than that of the cubic phase garnet. One method to stabilize the cubic phase garnet is by directly doping to substitute Li⁺, thereby generating lithium vacancies. Another method involves substituting Zr⁴⁺ with high-valence ions, which can stabilize the cubic phase garnet and achieve a high ionic conductivity approaching 10⁻³ S/cm. In one embodiment of the present invention, the garnet-type solid-state electrolyte is selected from the group consisting of LLZTO, LLZAO, LLZGO, and LALZNO. The aforementioned garnet-type solid-state electrolytes can be used individually or in any combination. In the appended examples, LLZTO is used.

Garnet-type solid-state electrolytes tend to react with carbon dioxide and water present in the air, resulting in the formation of lithium carbonate (Li₂CO₃) on their surfaces. Studies have shown that the presence of lithium carbonate leads to high interfacial impedance between the garnet-type solid-state electrolyte and lithium metal, which reduces the ionic conductivity and thereby adversely affects the performance of lithium-ion cells. Accordingly, one of the technical features of the present invention is that the garnet-type solid-state electrolyte is free of lithium carbonate.

X-ray photoelectron spectroscopy (XPS), X-ray fluorescence spectrometer (XRF) and Raman spectrum analysis are commonly used techniques for elemental analysis of ceramic materials. Among them, a Raman spectrometer can detect the elemental composition of a sample surface to a depth of about 0.1 μm and features lower detection limit, reaching 0.1 ppm. Accordingly, in this specification, a Raman spectrometer is used to confirm that the garnet-type solid-state electrolyte is free of lithium carbonate. A laser source of 532 nm and a laser power of 10 mW are used to perform surface analysis on the garnet-type solid-state electrolyte. The absence of lithium carbonate signal in the resultant Raman spectrum confirms the nonexistence of lithium carbonate. Since lithium carbonate is formed through the reaction between the surface of the garnet-type solid-state electrolyte and carbon dioxide and water, the absence of lithium carbonate on the surface of the garnet-type solid-state electrolyte indicates that the garnet-type solid-state electrolyte is free of lithium carbonate. Therefore, Raman spectrum analysis can be used to confirm that the lithium carbonate content in the garnet-type solid-state electrolyte used in the present invention is either 0 or less than 0.1 ppm. In the appended examples, the Raman spectrometer used is DXR Raman Microscope available from Thermo Fisher Scientific.

The garnet-type solid-state electrolyte, which does not contain (or is free of) lithium carbonate, can be obtained by subjecting the garnet-type solid-state electrolyte to an acid cleaning treatment. First, garnet-type solid-state electrolyte ceramic powders are added into an organic solvent, and an aqueous solution of strong acid is further added therein to obtain an initial mixing solution. The initial mixing solution is subjected to ultrasonic oscillation and then added with ultrapure water in an appropriate content to prevent the surface of the garnet-type solid-state electrolyte ceramic powders from being corroded by excessive strong acid. The initial mixing solution that has been subjected to ultrasonic oscillation is then placed in a centrifugal machine to perform centrifugation. The precipitates obtained after centrifugation are garnet-type solid-state electrolyte ceramic powders that do not contain lithium carbonate. Examples of the organic solvent include, but are not limited to, ethanol, isopropanol, and acetone. The aforementioned organic solvents can be used individually or in any combination. Examples of the aqueous solution of strong acid include, but are not limited to, an aqueous solution of hydrochloric acid, an aqueous solution of sulfuric acid, and an aqueous solution of nitric acid. The aforementioned aqueous solutions of strong acid can be used individually or in any combination. The concentration of the aqueous solution of strong acid can range from 0.1 M to 2.0 M. For example, the concentration of the aqueous solution of strong acid can be 0.1 M, 0.2 M, 0.3 M, 0.4 M, 0.5 M, 0.6 M, 0.7 M, 0.8 M, 0.9 M, 1.0 M, 1.1 M, 1.2 M, 1.3 M, 1.4 M, 1.5 M, 1.6 M, 1.7 M, 1.8 M, 1.9 M, or 2.0 M, or within a range between any two of the values described herein.

In one embodiment of the present invention, based on the total weight of the garnet-type solid-state electrolyte and the polymer filler, the content of the garnet-type solid-state electrolyte is 60 wt % or more, and more particularly, the content of the garnet-type solid-state electrolyte ranges from 60 wt % to 99 wt %. For example, based on the total weight of the garnet-type solid-state electrolyte and the polymer filler, the content of the garnet-type solid-state electrolyte can be 60 wt %, 61 wt %, 62 wt %, 63 wt %, 64 wt %, 65 wt %, 66 wt %, 67 wt %, 68 wt %, 69 wt %, 70 wt %, 71 wt %, 72 wt %, 73 wt %, 74 wt %, 75 wt %, 76 wt %, 77 wt %, 78 wt %, 79 wt %, 80 wt %, 81 wt %, 82 wt %, 83 wt %, 84 wt %, 85 wt %, 86 wt %, 87 wt %, 88 wt %, 89 wt %, 90 wt %, 91 wt %, 92 wt %, 93 wt %, 94 wt %, 95 wt %, 96 wt %, 97 wt %, 98 wt %, or 99 wt %, or within a range between any two of the values described herein. In terms of providing a lithium-ion cell with better mechanical performance, ionic conductivity, electrochemical stability, and cycling stability, based on the total weight of the garnet-type solid-state electrolyte and the polymer filler, the content of the garnet-type solid-state electrolyte preferably ranges from 90 wt % to 99 wt %, and more preferably ranges from 95 wt % to 99 wt %. For example, based on the total weight of the garnet-type solid-state electrolyte and the polymer filler, the content of the garnet-type solid-state electrolyte can be 95.0 wt %, 95.5 wt %, 96.0 wt %, 96.5 wt %, 97.0 wt %, or 97.5 wt %, or within a range between any two of the values described herein.

### 1.2. Polymer Filler

The solid-state electrolyte of the present invention incorporates the addition of a polymer filler, which enhances the flexibility and mechanical strength of the solid-state electrolyte, thereby improving its processability.

Examples of the material of the polymer filler include, but are not limited to, PTFE, PEO, PAN, and PMMA. These materials can be used individually or in any combination. In the appended examples, a PTFE filler is used.

The material of the polymer filler can have a weight average molecular weight (Mw) ranging from 300000 to 1000000. For example, the Mw of the material of the polymer filler can be 300000, 310000, 320000, 330000, 340000, 350000, 360000, 370000, 380000, 390000, 400000, 410000, 420000, 430000, 440000, 450000, 460000, 470000, 480000, 490000, 500000, 510000, 520000, 530000, 540000, 550000, 560000, 570000, 580000, 590000, 600000, 610000, 620000, 630000, 640000, 650000, 660000, 670000, 680000, 690000, 700000, 710000, 720000, 730000, 740000, 750000, 760000, 770000, 780000, 790000, 800000, 810000, 820000, 830000, 840000, 850000, 860000, 870000, 880000, 890000, 900000, 910000, 920000, 930000, 940000, 950000, 960000, 970000, 980000, 990000, or 1000000, or within a range between any two of the values described herein.

In the solid-state electrolyte of the present invention, based on the total weight of the garnet-type solid-state electrolyte and the polymer filler, the content of the polymer filler can range from 0.1 wt % to less than 40.0 wt %. For example, based on the total weight of the garnet-type solid-state electrolyte and the polymer filler, the content of the polymer filler can be 0.1 wt %, 0.5 wt %, 1.0 wt %, 2.0 wt %, 3.0 wt %, 4.0 wt %, 5.0 wt %, 6.0 wt %, 7.0 wt %, 8.0 wt %, 9.0 wt %, 10.0 wt %, 11.0 wt %, 12.0 wt %, 13.0 wt %, 14.0 wt %, 15.0 wt %, 16.0 wt %, 17.0 wt %, 18.0 wt %, 19.0 wt %, 20.0 wt %, 21.0 wt %, 22.0 wt %, 23.0 wt %, 24.0 wt %, 25.0 wt %, 26.0 wt %, 27.0 wt %, 28.0 wt %, 29.0 wt %, 30.0 wt %, 31.0 wt %, 32.0 wt %, 33.0 wt %, 34.0 wt %, 35.0 wt %, 36.0 wt %, 37.0 wt %, 38.0 wt %, 39.0 wt %, or 40.0 wt %, or within a range between any two of the values described herein. In the solid-state electrolyte of the present invention, the preferred content of the polymer filler based on the total weight of the garnet-type solid-state electrolyte and the polymer filler, is from 1.0 wt % to less than 10.0 wt %, and more specifically from 1.0 wt % to less than 5.0 wt %, for example, 2.5 wt %. When the content of the polymer filler falls within the above preferred range, the solid-state electrolyte of the present invention can have good flexibility and mechanical strength while retaining good ionic conductivity. Furthermore, the interfacial contact impedance between the solid-state electrolyte and the electrodes of the lithium-ion cell can be reduced, thereby effectively improving the mechanical performance and cycling performance of the lithium-ion cell.

### 1.3. Preparation of Solid-State Electrolyte

The method for preparing the solid-state electrolyte of the present invention is not particularly limited. In one embodiment of the present invention, the solid-state electrolyte is prepared by uniformly mixing garnet-type solid-state electrolyte ceramic powders that do not contain lithium carbonate with a polymer filler to obtain a mixture and then pressing the mixture. The particle size of the garnet-type solid-state electrolyte ceramic powders that do not contain lithium carbonate can be modified as needed, and the average particle size of the garnet-type solid-state electrolyte ceramic powders that do not contain lithium carbonate is preferably less than 100 μm. For example, the average particle size of the garnet-type solid-state electrolyte ceramic powders that do not contain lithium carbonate can be 95 μm, 90 μm, 85 μm, 80 μm, 75 μm, 70 μm, 65 μm, 60 μm, 55 μm, 50 μm, 45 μm, 40 μm, 35 μm, 30 μm, 25 μm, 20 μm, 15 μm, 10 μm, 5 μm, or 1 μm, or within a range between any two of the values described herein.

### 2. Lithium-Ion Cell

The solid-state electrolyte of the present invention is particularly suitable for a lithium-ion cell. Thus, the present invention also provides a lithium-ion cell, which comprises a positive electrode, a negative electrode, and the aforementioned solid-state electrolyte, wherein the solid-state electrolyte is disposed between the positive electrode and the negative electrode.

In the present invention, the negative electrode of the lithium-ion cell can be made of a material selected from lithium metal, a lithium-indium alloy, a lithium-aluminum alloy, and a silicon-lithium alloy. The aforementioned materials for making the negative electrode can be used individually or in any combination. In the appended examples, the material of the negative electrode is lithium.

In the present invention, the positive electrode of the lithium-ion cell can be made of a material selected from LFP, mono lithium cathode materials, binary lithium cathode materials, and ternary lithium cathode materials. Examples of the mono lithium cathode materials include, but are not limited to, LCO, lithium nickel oxide, and lithium manganese oxide. Examples of the binary lithium cathode materials include, but are not limited to, lithium nickel cobalt oxide, LNMO (lithium nickel manganese oxide), and lithium manganese cobalt oxide. Examples of the ternary lithium cathode materials include, but are not limited to, NCA and NCM. In one embodiment of the present invention, the positive electrode is made of a material selected from the group consisting of LFP, LCO, NCA, and NCM. Examples of NCA include, but are not limited to, LiNi_{0.8}Co_{0.15}Al_{0.05}O₂, LiNi_{0.8}Co_{0.18}Al_{0.02}O₂, and LiNi_{0.9}Co_{0.05}Al_{0.05}O₂. Examples of NCM include, but are not limited to, LiNi_{0.33}Co_{0.33}Mn_{0.33}O₂ (NCM111), LiNi_{0.5}Co_{0.2}Mn_{0.3}O₂ (NCM523), LiNi_{0.6}Co_{0.2}Mn_{0.2}O₂ (NCM622) and LiNi_{0.8}Co_{0.1}Mn_{0.1}O₂ (NCM811). In the appended examples, the material of the positive electrode is LFP.

The lithium-ion cell of the present invention can further comprise an ionic liquid between the positive electrode and the solid-state electrolyte, as well as between the negative electrode and the solid-state electrolyte, to have further improved interfacial stability and reduced interfacial impedance between the positive electrode and the solid-state electrolyte, as well as between the negative electrode and the solid-state electrolyte, wherein the ionic liquid contains a lithium salt. The ionic liquid containing a lithium salt can enhance lithium ion mobility, thereby increasing ionic conductivity, resulting in improved cell cycling performance. In one embodiment of the present invention, examples of the lithium salt contained in the ionic liquid include, but are not limited to, LiTFSI, LiPF₆, LiBF₄, LiClO₄, LiAsF₆, and LiCF₃SO₃. The aforementioned lithium salts can be used individually or in any combination. Examples of the organic solvent that can be used to form the ionic liquid include, but are not limited to, triethylene glycol dimethyl ether (TEGDME), diethylene glycol dimethyl ether, ethylene glycol dimethyl ether, diethylene glycol diethyl ether, dipropylene glycol dimethyl ether, and propylene glycol dimethyl ether. The aforementioned organic solvents can be used individually or in any combination. In the appended examples, the ionic liquid containing a lithium salt is a LiTFSI-containing TEGDME solution. Without being restricted by theories, it is believed that the ionic liquid containing a lithium salt can form a stable lithium-ion transfer interface and reduce interfacial impedance. In addition, the ionic liquid containing a lithium salt helps to mitigate harmful side reactions and can enhance the performance of the electrodes, preventing them from losing effectiveness in a short period of time.

### 3. Example

### 3.1. Preparation and Test of Solid-State Electrolyte

### [Preparation of LLZTO Powders That do not Contain Lithium Carbonate]

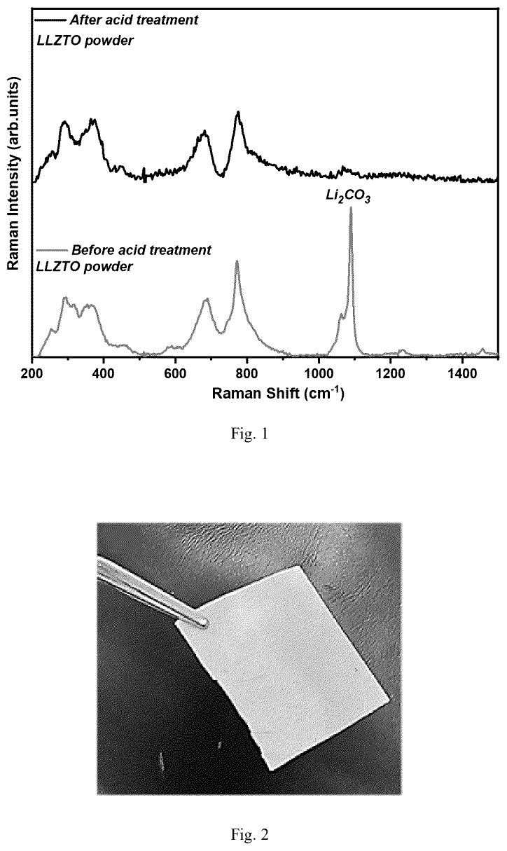

1 (one) g of Li_{6.4}La₃Zr_{1.4}Ta_{0.6}O₁₂ (LLZTO) powders was prepared and subjected to a surface analysis using the Raman spectrometer (model number: DXR Raman Microscope, available from Thermo Fisher Scientific) with a laser source of 532 nm and a laser power of 10 mW. The result is shown in FIG. 1 and represented by “before acid treatment”. As shown in FIG. 1, the LLZTO powders that were not subjected to an acid treatment show signals of lithium carbonate in the Raman spectrum, which indicates that the LLZTO powders contain lithium carbonate.

The LLZTO powders were then subjected to an acid treatment. First, 1 (one) g of LLZTO powders (i.e., LLZTO powders that contain lithium carbonate) was added into a mixing solvent containing 1 (one) mL of ethanol and 3 mL of isopropanol, and uniformly stirred to form a well-mixed dispersion. Next, the dispersion was mixed with 12 mL of 1 (one) M hydrochloric acid to obtain an initial mixing solution. Afterward, the initial mixing solution was placed in an ultrasonicator and subjected to ultrasonic oscillation for 60 seconds; then, 10 mL of ultrapure water was added to dilute hydrochloric acid. Subsequently, the diluted mixing solution was placed in a centrifugal machine and subjected to centrifugation at a rotational speed of 8000 rpm for 10 minutes. The precipitates obtained after centrifugation are LLZTO powders that do not contain lithium carbonate.

The LLZTO powders that have been subjected to an acid treatment were subjected to a surface analysis using the Raman spectrometer DXR Raman Microscope with a laser source of 532 nm and a laser power of 10 mW. The result is also shown in FIG. 1 and represented by “after acid treatment”. As shown in FIG. 1, the LLZTO powders that have been subjected to an acid treatment do not show signals of lithium carbonate in the Raman spectrum, which indicates that the LLZTO powders that have been subjected to an acid treatment do not contain lithium carbonate.

### Example 1

### Preparation of the Solid-State Electrolyte of the Present Invention

The solid-state electrolyte sheet of Example 1 was prepared as follows. In a glove box with both water and oxygen levels below 1 ppm, 1 (one) g (97.5 wt %) of the LLZTO powders that have been subjected to an acid treatment and do not contain lithium carbonate was uniformly mixed with 0.026 g (2.5 wt %) of PTFE powders in a mortar by means of a solventless process to obtain a mixture. Afterward, the mixture was placed into a mold and hot-pressed into a ceramic sheet by uniaxial pressing using a CrushIR 15 ton Digital Press (model number: 181-1100, available from PIKE Technologies). The hot-pressing conditions are as follows: a hot-pressing temperature of 100° C., a hot-pressing pressure of 200 MPa, and a hot-pressing duration of 10 minutes. The ceramic sheet was cut into circular thin sheet with a diameter of 12 mm and a thickness of 200μm, thereby obtaining the solid-state electrolyte sheet of Example 1.

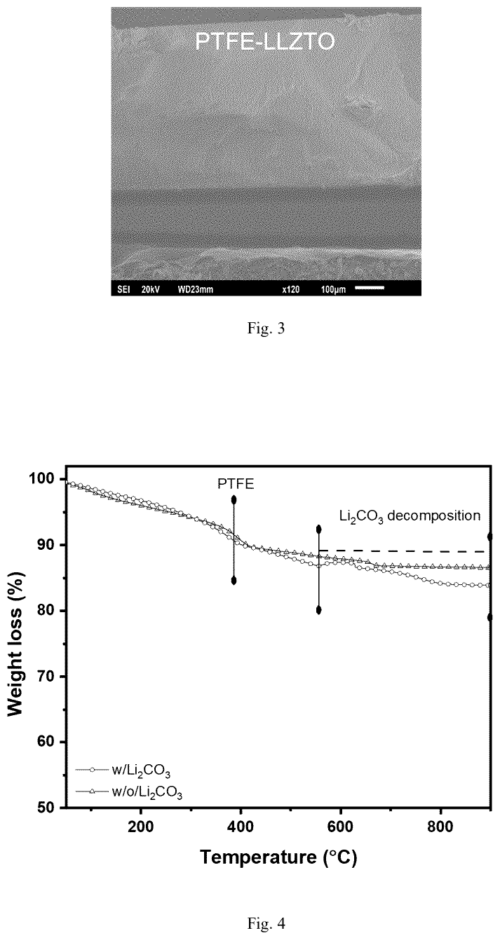

A photograph of the aforementioned ceramic sheet was taken using a camera, as shown in FIG. 2. A cross-sectional view of the aforementioned ceramic sheet was captured using a scanning electron microscope (model number: JSM-6510, available from JEOL), as shown in FIG. 3.

### Comparative Example 1

### Preparation of Solid-State Electrolyte that does not Belong to the Present Invention

The preparation procedures of Example 1 were repeated to prepare the solid-state electrolyte sheet of Comparative Example 1, except that the LLZTO powders that have been subjected to an acid treatment were replaced with LLZTO powders containing lithium carbonate that had not undergone an acid treatment.

### [Thermogravimetric Analysis of Solid-State Electrolyte]

The solid-state electrolyte sheets of Example 1 and Comparative Example 1 were analyzed respectively using a thermogravimetric analyzer (model number: STA 8122, available from Rigaku); and the results are shown in FIG. 4. The test conditions for the thermogravimetric analyzer are as follows: argon is introduced at a flow rate of 10 mL/min to create an argon atmosphere, and the temperature is raised at a heating rate of 5°C./min from room temperature to 900° C.

As shown in FIG. 4, after PTFE decomposed at 400° C., the amount of the garnet-type solid-state electrolyte ceramic powder of Example 1 and the amount of the garnet-type solid-state electrolyte ceramic powder of Comparative Example 1 are both greater than 90 wt %. However, when the temperature rises to 800° C., it can be observed that the weight loss of the solid-state electrolyte sheet of Comparative Example 1 (represented by w/Li₂CO₃) is larger than the weight loss of the solid-state electrolyte sheet of Example 1 (represented by w/o/Li₂CO₃). This is because lithium carbonate begins to decompose at temperatures between 500° C. and 800° C.

### [Preparation and Test of Symmetric Cell]

Symmetric cells of Example 1 and Comparative Example 1 were prepared respectively by using the solid-state electrolyte sheets of Example 1 and Comparative Example 1. The following materials were prepared in advance: housings for the button cell, lithium metal sheets with a diameter of 10 mm and a thickness of 0.025 mm as electrode sheets, and an ionic liquid containing lithium salts with a concentration of 1 M. The 1 M lithium salts-containing ionic liquid was obtained by dissolving LiTFSI as lithium salts in TEGDME.

The assembly of the symmetric cell was conducted in a glove box with both water and oxygen levels below 1 ppm. First, the bottom cover of the button cell was placed, followed by the lithium metal sheet (electrode sheet), and then 5 μL of 1 M lithium salts-containing ionic liquid was added onto the electrode sheet. Afterward, the solid-state electrolyte sheet of Example 1 or Comparative Example 1 was placed thereon, followed by adding 5 μL of 1 M lithium salts-containing ionic liquid onto the solid-state electrolyte sheet. Finally, the lithium metal sheet (electrode sheet) and the top cover of button cell were sequentially placed to obtain a stacking object. The stacking object was pressed using a button cell tablet press at a pressure of 40 MPa, resulting in the symmetric cells of Example 1 and Comparative Example 1.

The impedance of the symmetric cells of Example 1 and Comparative Example 1 was measured using a Modular potentiostats/galvanostats (Autolab PGSTAT302N) at room temperature, wherein the range of alternating current frequency was set from 0.1 Hz to 10⁷ Hz, and the results are shown in FIG. 5. As can be seen from FIG. 5, as compared to the symmetric cell of Comparative Example 1 (represented by w/Li₂CO₃), the impedance of the symmetric cell of Example 1 (represented by w/o/Li₂CO₃) is significantly lower. This demonstrates that the solid-state electrolyte that does not contain lithium carbonate can effectively reduce the interfacial impedance between the solid-state electrolyte and the electrode, and can possess a stable interface. In other words, the lithium ion distribution in the symmetric cell is uniform, and the electrode interface remains stable.

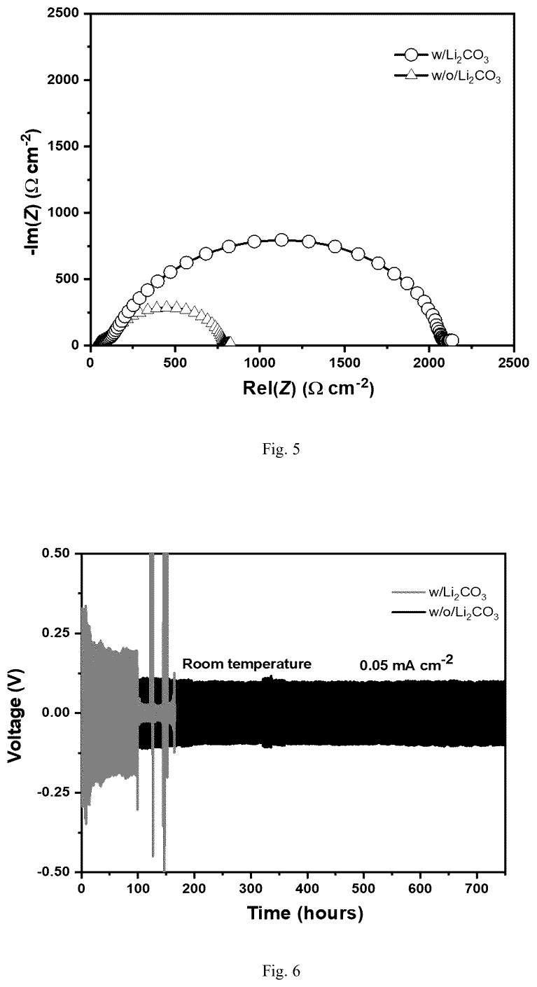

In addition, under a current density of 0.05 mAh/cm² and at room temperature, the symmetric cells of Example 1 and Comparative Example 1 were cycled, and the results are shown in FIG. 6. As can be seen from FIG. 6, the symmetric cell of Example 1 (represented by w/o/Li₂CO₃) maintains cycling stability over 700 hours at room temperature. By contrast, the symmetric cell of Comparative Example 1 (represented by w/Li₂CO₃) maintains cycling stability for only about 100 hours. This demonstrates that the solid-state electrolyte that does not contain lithium carbonate can effectively reduce the interfacial impedance between the solid-state electrolyte and the electrode, thereby improving the cycle life of the lithium-ion cell.

### 3.2. Preparation and Test of Lithium-Ion Cell

First, LFP as an active material for the positive electrode, conductive carbon KS6 as a carbon source, and poly(vinylidene difluoride) (PVDF) as a binder were put into a mortar in a weight ratio of 75:20:5, and ground for 20 minutes. Then, 2.0 mL of N-methyl-2-pyrrolidone (NMP) as a solvent was added to the mortar; and the mixture was uniformly mixed to obtain a slurry. Afterward, the slurry was coated onto an aluminum foil to form a layer with a thickness of about 150 μm, and the coated aluminum foil was dried in a vacuum oven at 100° C. for 12 hours to remove the solvent. Next, the dried film formed from the slurry was peeled off from the aluminum foil and cut into a circular positive electrode sheet with a diameter of 8 mm and a thickness of 100 μm.

In addition, a lithium metal sheet with a diameter of 8 mm and a thickness of 0.025 mm was prepared as a negative electrode sheet.

Lithium-ion cells of Example 1 and Comparative Example 1 were prepared respectively by using the solid-state electrolyte sheets of Example 1 and Comparative Example 1. The following materials were prepared in advance: housings for the button cell, and an ionic liquid containing lithium salts with a concentration of 1 M. The 1 M lithium salts-containing ionic liquid was obtained by dissolving LiTFSI as lithium salts in TEGDME. The assembly of the lithium-ion cell was conducted in a glove box with both water and oxygen levels below 1 ppm. First, the bottom cover of the button cell was placed, followed by the positive electrode sheet, and then 5 μL of 1 M lithium salts-containing ionic liquid was added onto the positive electrode sheet. Afterward, the solid-state electrolyte sheet of Example 1 or Comparative Example 1 was placed thereon, followed by adding 5 μL of 1 M lithium salts-containing ionic liquid onto the solid-state electrolyte sheet. Finally, the negative electrode sheet and the top cover of button cell were sequentially placed to obtain a stacking object. The stacking object was pressed using a button cell tablet press at a pressure of 40 MPa, resulting in the lithium-ion cells of Example 1 and Comparative Example 1.

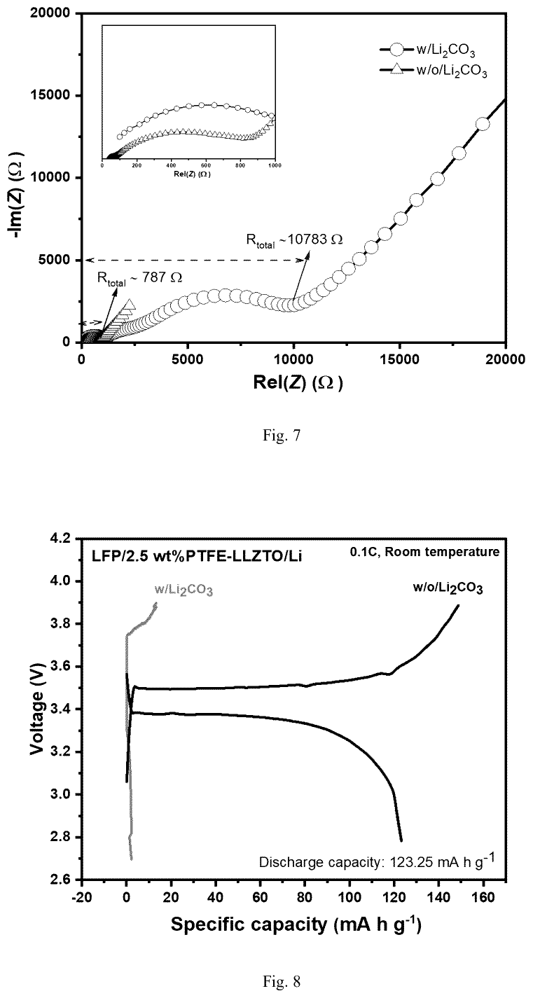

The impedance of the lithium-ion cells of Example 1 and Comparative Example 1 was measured using a Modular potentiostats/galvanostats (Autolab PGSTAT302N) at room temperature, wherein the range of alternating current frequency was set from 0.1 Hz to 10⁷ Hz, and the results are shown in FIG. 7. As can be seen from FIG. 7, the sum of the bulk impedance and the interfacial impedance of the lithium-ion cell of Comparative Example 1 (represented by w/Li₂CO₃) is up to 10783 Ω, while the sum of the bulk impedance and the interfacial impedance of the lithium-ion cell of Example 1 (represented by w/o/Li₂CO₃) is only about 787 Ω. In addition, as shown in the enlarged part in the upper left of FIG. 7, the bulk impedance of the lithium-ion cell of Comparative Example 1 in the high frequency region is also greater than the bulk impedance of the lithium-ion cell of Example 1. This demonstrates that the solid-state electrolyte that does not contain lithium carbonate can effectively reduce the interfacial impedance between the solid-state electrolyte and the electrode.

In addition, under a charge-discharge current of 0.1 C and at room temperature, the lithium-ion cells of Example 1 and Comparative Example 1 were cycled for the first charge-discharge, and the results are shown in FIG. 8. As can be seen from FIG. 8, the first charge-discharge cycle of the lithium-ion cell of Comparative Example 1 (represented by w/Li₂CO₃) could not be completed, whereas the lithium-ion cell of Example 1 (represented by w/o/Li₂CO₃) successfully completed the first charge-discharge and achieved a first discharge capacity of 123.25 mAh/g. This demonstrates that the solid-state electrolyte that does not contain lithium carbonate can effectively reduce the interfacial impedance between the solid-state electrolyte and the electrode, maintain a stable interface, and improve the conduction of lithium ions, thereby enhancing the electrochemical performance of the lithium-ion cell.

The above examples are used to illustrate the principle and efficacy of the present invention and show the inventive features thereof, but are not used to limit the scope of the present invention. People skilled in this field may proceed with a variety of modifications and replacements based on the disclosures and suggestions of the invention as described. Therefore, the scope of protection of the present invention is that as defined in the claims as appended.

What is claimed is:

1. A solid-state electrolyte for lithium-ion cells, which comprises a garnet-type solid-state electrolyte and a polymer filler, wherein the polymer filler is dispersed within the garnet-type solid-state electrolyte, and the garnet-type solid-state electrolyte does not contain lithium carbonate, and wherein the content of the garnet-type solid-state electrolyte is 60 wt % or more based on the total weight of the garnet-type solid-state electrolyte and the polymer filler.

2. The solid-state electrolyte of claim 1, wherein the garnet-type solid-state electrolyte is selected from the group consisting of Li_{6.4}La₃Zr_{1.4}Ta_{0.6}O₁₂ (LLZTO), Li_{6.4}La₃Zr₂Al_{0.2}O₁₂ (LLZAO), Li_{6.4}La₃Zr₂Ga_{0.2}O₁₂ (LLZGO), Li_{6.25}Al_{0.20}La₃Zr_{1.85}Nb_{0.15}O₁₂ (LALZNO), and combinations thereof.

3. The solid-state electrolyte of claim 1, wherein the garnet-type solid-state electrolyte is provided by garnet-type solid-state electrolyte ceramic powder that does not contain lithium carbonate.

4. The solid-state electrolyte of claim 3, wherein the garnet-type solid-state electrolyte ceramic powder that does not contain lithium carbonate has an average particle size of less than 100 μm.

5. The solid-state electrolyte of claim 1, wherein the polymer filler is made of a material selected from the group consisting of polytetrafluoroethene (PTFE), poly(ethylene oxide) (PEO), polyacrylonitrile (PAN), poly(methyl methacrylate) (PMMA), and combinations thereof.

6. The solid-state electrolyte of claim 2, wherein the polymer filler is made of a material selected from the group consisting of polytetrafluoroethene (PTFE), poly(ethylene oxide) (PEO), polyacrylonitrile (PAN), poly(methyl methacrylate) (PMMA), and combinations thereof.

7. The solid-state electrolyte of claim 3, wherein the polymer filler is made of a material selected from the group consisting of polytetrafluoroethene (PTFE), poly(ethylene oxide) (PEO), polyacrylonitrile (PAN), poly(methyl methacrylate) (PMMA), and combinations thereof.

8. The solid-state electrolyte of claim 4, wherein the polymer filler is made of a material selected from the group consisting of polytetrafluoroethene (PTFE), poly(ethylene oxide) (PEO), polyacrylonitrile (PAN), poly(methyl methacrylate) (PMMA), and combinations thereof.

9. The solid-state electrolyte of claim 1, wherein based on the total weight of the garnet-type solid-state electrolyte and the polymer filler, the content of the polymer filler ranges from 0.1 wt % to less than 40 wt %.

10. The solid-state electrolyte of claim 2, wherein based on the total weight of the garnet-type solid-state electrolyte and the polymer filler, the content of the polymer filler ranges from 0.1 wt % to less than 40 wt %.

11. The solid-state electrolyte of claim 3, wherein based on the total weight of the garnet-type solid-state electrolyte and the polymer filler, the content of the polymer filler ranges from 0.1 wt % to less than 40 wt %.

12. The solid-state electrolyte of claim 4, wherein based on the total weight of the garnet-type solid-state electrolyte and the polymer filler, the content of the polymer filler ranges from 0.1 wt % to less than 40 wt %.

13. A lithium-ion cell, which comprises a positive electrode, a negative electrode, and the solid-state electrolyte of claim 1.

14. The lithium-ion cell of claim 13, wherein the positive electrode is made of a material selected from the group consisting of LiFePO₄ (LFP), LiCoO₂ (LCO), lithium nickel cobalt aluminum oxide (NCA), and lithium nickel cobalt manganese oxide (NCM).

15. The lithium-ion cell of claim 13, wherein the negative electrode is made of a material selected from the group consisting of lithium metal, a lithium-indium alloy, a lithium-aluminum alloy, a silicon-lithium alloy, and combinations thereof.

16. The lithium-ion cell of claim 13, which further comprises an ionic liquid between the positive electrode and the solid-state electrolyte, as well as between the negative electrode and the solid-state electrolyte, wherein the ionic liquid contains a lithium salt.

17. The lithium-ion cell of claim 16, wherein the lithium salt is selected from the group consisting of lithium bis(trifluoromethanesulfonyl)imide (LiTFSI), LiPF₆, LiBF₄, LiClO₄, LiAsF₆, LiCF₃SO₃, and combinations thereof.
